(19) United States
(12) Patent Application Publication
(10) Pub. No.: US 2025/0184399 A1
(43) Pub. Date: Jun. 5, 2025

(54) LIGHTWEIGHT SUPERVISORY CONTROL AND DATA ACQUISITION (SCADA) SYSTEM AND METHOD

(71) Applicant: HONEYWELL INTERNATIONAL INC., Charlotte, NC (US)

(72) Inventors: Lifen ZHANG, Charlotte, NC (US); Yingying ZHU, Charlotte, NC (US); Shaomin SUN, Charlotte, NC (US); Durbar WANG, Charlotte, NC (US)

(21) Appl. No.: 18/843,929

(22) PCT Filed: Mar. 9, 2022
(86) PCT No.: PCT/CN2022/079877

§ 371 Date: Sep. 4, 2024

(51) Int. Cl. H04L 67/141; H04L 12/66

(52) U.S. Cl. CPC H04L 67/141; H04L 12/66

(57) ABSTRACT

A system includes a message broker that uses a publish/subscribe messaging protocol. An edge gateway operatively couples one or more edge devices to the message broker. The edge gateway receives information from one or more of the edge devices and publishes at least some of the received information to the message broker in a protocol that is compatible with the publish/subscribe messaging protocol of the message broker. A host application is operatively coupled to the message broker and subscribes to at least some of the information published by the edge gateway. The edge gateway is configured to determine an edge gateway connection state and publish the edge gateway connection state to the message broker. The host application is configured to determine a host application connection state of the host application and publish the host application connection state to the message broker.

### TECHNICAL FIELD

The present disclosure pertains generally to supervisory control and data acquisition (SCADA) systems, and more particular to communication techniques used in such systems.

### BACKGROUND

Devices within control systems, such as SCADA systems, need to communicate. Some systems include a large number of devices that are not all configured to communicate using a common communication protocol. Using differing communication protocols in a control system can introduce significant complexities during system deployment and configuration, can be error prone, and can result in an inefficient use of available bandwidth in the system. A need remains for ways to improve communication between devices in such control systems.

### SUMMARY

This disclosure relates generally to control systems, and more particular to communication techniques used in such systems. An example may be found in a system that includes a message broker that uses a publish/subscribe messaging protocol. An edge gateway operatively couples one or more edge devices to the message broker. The edge gateway is configured to receive information from one or more of the edge devices and publishing at least some of the received information to the message broker in a protocol that is compatible with the publish/subscribe messaging protocol of the message broker. In some cases, the edge gateway is configured to convert at least some information received from one or more of the edge devices from a protocol that is incompatible with the publish/subscribe messaging protocol of the message broker to a protocol that is compatible with the publish/subscribe messaging protocol of the message broker before publishing the information to the message broker. A host application is operatively coupled to the message broker. The host application subscribes to at least some of the information published by the edge gateway to the message broker.

The edge gateway is configured to determine an edge gateway connection state and publish the edge gateway connection state to the message broker. The edge gateway connection state includes, for example, an online and offline connection state. The host application is configured to determine a host application connection state of the host application and publish the host application connection state to the message broker. The host application connection state including an online and an offline connection state.

In some cases, the host application connection state is set to online when the host application is connected to the message broker, and the host application connection state is set to offline when the host application is not connected to the message broker. The edge gateway connection state is set to online when the edge gateway is connected to the message broker and the host application connection state is set to online, and the edge gateway connection state is set to offline when the edge gateway is not connected to the message broker or when the edge gateway is connected to the message broker but the host application connection state is set to offline.

In some cases, a plurality of host applications are provided. Each of the plurality of host applications includes a host application identifier, with one of the plurality of host applications identified as a primary host application. In some instances, when the host application connection state of the primary host application goes offline, another of the plurality of host applications is automatically identified as a new primary host application, and the edge gateway automatically switches to connect to the new primary host application via the message broker.

In some cases, the edge gateway connection state includes online, offline and searching for a primary host application. The edge gateway may store an ordered list of the plurality of host applications, wherein when the host application connection state of the primary host application goes offline, a next primary host application in the ordered list of the plurality of host applications is automatically identified as the new primary host application, and the edge gateway automatically switches to connect to the new primary host application via the message broker.

In some instances, a client application is operatively coupled to the message broker. The client application subscribes to at least some of the information published by the edge gateway to the message broker. In some cases, the client application is configured to publish control information to the message broker to control one or more of the edge devices operatively coupled to the edge gateway. The message broker may be configured to verify that the client application is authorized to publish control information for the one or more edge devices, and if the client application is not authorized, the message broker may be configured to not deliver the published control information.

Another example may be found in a system including a message broker that uses a publish/subscribe messaging protocol and an edge gateway that operatively couples one or more edge devices to the message broker. The edge gateway receives information from one or more of the edge devices and publishes at least some of the received information to the message broker in a protocol that is compatible with the publish/subscribe messaging protocol of the message broker. A host application is operatively coupled to the message broker and subscribes to at least some of the information published by the edge gateway to the message broker. The edge gateway is configured to convert at least some information received from one or more of the edge devices from a protocol that is incompatible with the publish/subscribe messaging protocol of the message broker to a protocol that is compatible with the publish/subscribe messaging protocol of the message broker before publishing the information to the message broker.

Another example may be found in a system that includes a message broker that uses a publish/subscribe messaging protocol. An edge gateway operatively couples one or more edge devices to the message broker. The edge gateway receives information from one or more of the edge devices and publishes at least some of the received information to the message broker in a protocol that is compatible with the publish/subscribe messaging protocol of the message broker. In this example, a plurality of host applications are operatively coupled to the message broker. The plurality of host applications includes a primary host application that subscribes to at least some of the information published by the edge gateway to the message broker. When the primary host application connection goes offline, another of the plurality of host applications is automatically identified as a new primary host application, and the edge gateway and the new primary host application automatically connect via the message broker. This may result in some level of redundancy in the system, thereby increasing the reliability and thus availability of the system.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram of an illustrative system;

FIG. 2 is a schematic block diagram of an illustrative building management system;

FIG. 3 is a schematic block diagram of a control system that uses an illustrative sparkplug driver that is configured to provide an interface between one or more host applications and/or one or more edge gateways with a common MQTT message broker;

FIG. 4 is an illustrative primary application high availability state flow diagram;

FIG. 5 is an illustrative state management process flow diagram;

FIG. 6 is an illustrative initiative status update flow diagram;

FIG. 7 is an illustrative flow diagram showing how messages of different formats are converted by the edge gateway into sparkplug messages;

FIG. 8 is an illustrative flow diagram showing how device or sensors data is converted into sparkplug messages;

FIG. 9 is a flow diagram showing an illustrative state machine of a host application;

FIG. 10 is a flow diagram showing an illustrative state machine of an edge gateway;

FIG. 11 is a flow diagram showing an illustrative state machine of a client application;

FIG. 12 is a flow diagram showing an illustrative workflow of a secondary host application becoming the primary host application;

FIG. 13 is a flow diagram showing an illustrative method of publishing message permission control;

FIG. 14 is a flow diagram showing an illustrative method of subscribing message permission control; and

FIG. 15 is a schematic view of several illustrative use cases.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

The term “average” as used herein represents a number or expression expressing the central or typical value in a set of data, in particular the mode, median, or (most commonly) the mean, which is calculated by dividing the sum of the values in the set by their number.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

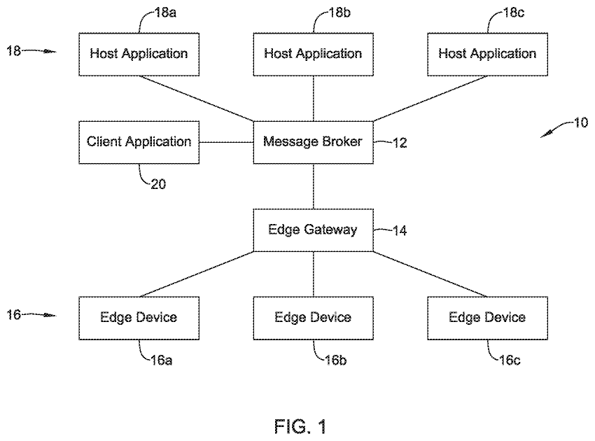

FIG. 1 is a schematic block diagram of an illustrative system 10 by which a variety of devices can communicate with each other. The illustrative system 10 may be an example of a building control system that includes one or more of an Heating, Ventilation and/or Air Conditioning (HVAC) system, a security system, an access control system, a fire suppression system, and/or any other suitable system. In some cases, the illustrative system 10 may be an example of an industrial control system, such as an industrial process control system. In some instances, the illustrative system 10 may be an example of a supervisory control and data acquisition (SCADA) system.

The illustrative system 10 includes a message broker 12 that uses a publish/subscribe messaging protocol. An edge gateway 14 is operatively coupled to the message broker and is also coupled to each of a plurality of edge devices 16, individually labeled as 16a, 16b and 16c. While a total of three edge devices 16 are shown, in some cases there may be a single edge device 16, or two edge devices 16. In some cases, there may be considerably more than three edge devices 16. At least some of the edge devices 16 may be building and/or process control devices and/or building and/or process control sensors, for example.

The illustrative edge gateway 14 operatively couples the edge devices 16 to the message broker 12. In some instances, the edge gateway 14 is configured to receive information from one or more of the edge devices 16 and to publish at least some of the received information to the message broker 12 in a protocol that is compatible with the publish/subscribe messaging protocol of the message broker 12. In some instances, the edge gateway 14 may receive information from one or more of the edge devices 16 in a protocol that is incompatible with the publish/subscribe messaging protocol of the message broker 12. In some cases, each of two or more of the edge devices 16 may transmit information to the edge gateway 14 using a different communication protocol from another one of the two or more edge devices 16.

In some cases, the message broker 12 may be an MQTT message broker, and the publish/subscribe messaging protocol may include a sparkplug publish/subscribe messaging protocol. MQTT is a lightweight, publish-subscribe network protocol that transports messages between devices. While the MQTT protocol usually runs over TCP/IP, it is contemplated that any network protocol that provides ordered, lossless, bi-directional connections can be used. While MQTT is used here as an example publish/subscribe messaging protocol, it is contemplated that any other suitable publish/subscribe messaging protocol may be used. Also, in some instances, the edge gateway 14 may receive information from one or more of the edge devices 16 in a protocol that is incompatible with the publish/subscribe messaging protocol of the message broker 12, such as in one or more of OPC, Modbus and BACnet.

In the example shown, one or more host applications 18 are operatively coupled to the message broker 12. As shown, a total of three host applications 18, individually labeled as 18a, 18b and 18c, are operatively coupled to the message broker 12. In some cases, there may only be a single host application 18, or two host applications 18. In some cases, there may be four, five or more host applications 18. One or more of the host applications 18 are configured to subscribe to at least some of the information published by the edge gateway 14 to the message broker 12. In some instances, a first host application 18 may be configured to subscribe to a first subset of the information published by the edge gateway 14 to the message broker 12 while a second host application 18 may be configured to subscribe to a second subset of the information published by the edge gateway 14 to the message broker 12, for example.

In some instances, the edge gateway 14 may be configured to determine an edge gateway connection state and publish the edge gateway connection state to the message broker 12. The edge gateway connection state may include, for example, online and offline. The host application 18 may be configured to determine a host application connection state of the corresponding host application 18 and publish the host application connection state to the message broker 12. The host application connection state may include, for example online and offline.

In some cases, the host application connection state may be set to online when the host application 18 is successfully connected to the message broker 12, and the host application connection state is set to offline when the host application 18 is not successfully connected to the message broker 12. The edge gateway connection state may be set to online when the edge gateway 14 is successfully connected to the message broker 12 and the host application connection state is set to online, and the edge gateway connection state may be set to offline when the edge gateway 14 is not successfully connected to the message broker 12 or when the edge gateway 14 is connected to the message broker 12 but the host application connection state is set to offline.

In some cases, when the system 10 includes a plurality of host applications 18, each of the plurality of host applications 18 includes a host application identifier, with one of the plurality of host applications 18 identified as a primary host application. When the host application connection state of the primary host application goes offline, another of the plurality of host applications 18 is automatically identified as a new primary host application, and the edge gateway 14 automatically switches to connect to the new primary host application via the message broker 12. In some instances, the edge gateway connection state may include online, offline and searching for the primary host application. In some instances, the edge gateway 14 may store an ordered list of the plurality of host applications, wherein when the host application connection state of the primary host application goes offline, a next primary host application in the ordered list of the plurality of host applications is automatically identified and selected as the new primary host application, and the edge gateway 14 automatically switches to connect to the new primary host application via the message broker 12.

The edge gateway 14 may be configured to convert at least some information received from one or more of the edge devices 16 from a protocol that is incompatible with the publish/subscribe messaging protocol of the message broker 12 to a protocol that is compatible with the publish/subscribe messaging protocol of the message broker 12 before publishing the information to the message broker 12. The host application 18 may be configured to publish control information to the message broker 12 to control one or more of the edge devices 16 operatively coupled to the edge gateway 14, and the edge gateway 14 may be configured to subscribe to at least some of the control information published by the host application 18.

In some cases, the illustrative system 10 may further include a client application 20 that is operatively coupled to the message broker 12. While a single client application 20 is shown, it will be appreciated that the system 10 may include any number of client applications 20. The client application 20 may subscribe to at least some of the information published by the edge gateway 14 to the message broker 12. The client application 20 may be configured to publish control information to the message broker 12 to control one or more of the edge devices 16 operatively coupled to the edge gateway 14, wherein the message broker 12 may be configured to verify that the client application 20 is authorized to publish control information for the one or more edge devices 16, and if the client application 20 is not authorized, the message broker 12 may be configured to not deliver the published control information.

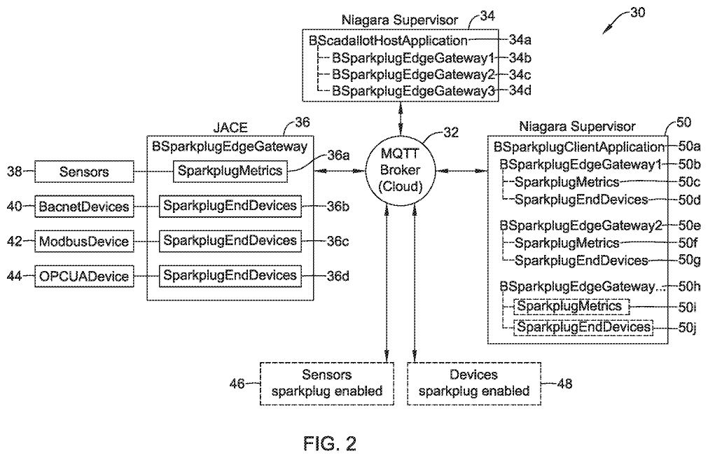

FIG. 2 is a schematic block diagram of an illustrative building management system 30. The illustrative building management system 30 may be considered as being an example of the illustrative system 10 of FIG. 1. Features ascribed to the illustrative system 10 may be present within the building management system 30, and features ascribed to the building management system 30 may be present within the illustrative system 10. The illustrative building management system 30 includes an MQTT broker 32 which may be considered as being an example of the message broker 12 of FIG. 1. The MQTT broker 32 is operably coupled with a Niagara™ Supervisor 34. The Niagara™ Supervisor 34 may be considered as being an example of host application 18 of FIG. 1. The Niagara™ Supervisor 34 may include a BScadallotHostApplication 34a, a BSparkplugEdgeGateway1 component 34b, a BSparkplugEdgeGateway2 component 34c and a BSparkplugEdgeGateway3 component 34d. In some cases, the Niagara™ Supervisor 34 may include a different number of BSparkplugEdgeGateways component, for example. Each of the BSparkplugEdgeGateway components 34b-34d of the Niagara™ Supervisor 34 host application may, for example, store information that establishes the subscription and/or publication parameters relative to the corresponding edge gateway.

The MQTT broker 32 is operably coupled with and can send and receive information with a JACE (Java Application Control Engine) 36 running in each of one or more edge gateways. The JACE 36 may implement a BSparkplugEdgeGateway that controls communication between the edge gateway and the MQTT broker 32, and between the edge gateway and the non-compatible end devices. In the example shown, the JACE 36 includes one or more of a SparkplugMetrics block 36a and a plurality of SparkplugEndDevices blocks 36b-36d, each for providing an interface between non-sparkplug compatible devices and the MQTT broker 32. The SparkplugMetrics block 36a may be operably coupled with sensors 38. The SparkplugEndDevices block 36b may be operably coupled with BACnet devices 40. The SparkplugEndDevices block 36c may be operably coupled with Modbus devices 42. The SparkplugEndDevices block 36d may be operably coupled with OPCUA devices 44. These are just examples.

In some cases, the building management system 30 may include sensors 46 that are already sparkplug enabled, and thus compatible with the MQTT broker 32. That is, the sensors 46 are able to communicate directly with the MQTT broker 32 without having to go through a corresponding block within the JACE 36. The building management system 30 may include other devices 48 that are sparkplug enabled. The devices 48 are able to communicate directly with the MQTT broker 32 without having to go through a corresponding block within the JACE 36.

The illustrative building management system includes a Niagara™ Supervisor 50 that is operably coupled with the MQTT broker 32. The Niagara™ Supervisor 50 may be considered as being an example of the client application 20 of FIG. 1. The Niagara™ Supervisor 50 includes a BSparkplugClientApplication 50a, a BSparkplugEdgeGateway1 Component 50b, a BSparkplugEdgeGateway2 component 5e and a BSparkplugEdgeGateway component 50h, in the example shown, each of the BSparkplugEdgeGateway1 component 50b, BSparkplugEdgeGateway2 component 5e and BSparkplugEdgeGateway component 50h include corresponding SparkplugMetrics (50c, 50f, 50i) and SparkplugEndDevices (50d, 50g, 50j). Each of the BSparkplugEdgeGateway components 50b, 50e and 50h of the Niagara™ Supervisor 50 client application may, for example, store information that establishes subscription, publication and/or access right parameters relative to the corresponding edge gateway.

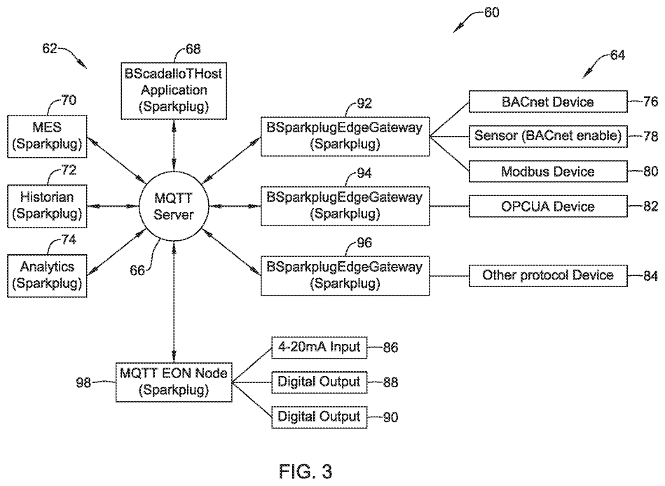

FIG. 3 is a schematic block diagram of an illustrative sparkplug system 60 including an IT (information technology) side 62 and an OT (operational technology) side 64. On the IT side 62, the sparkplug system 60 includes an MQTT server 66 that is configured to communicate back and forth with a BScadalloHostApplication block 68 (host application), a MES (sparkplug) block 70, a Historian (sparkplug) block 72 and an Analytics (sparkplug) block 74.

On the OT side 64, the sparkplug system 60 includes a BACnet device block 76, a BACnet-enabled sensor block 78, a Modbus block 80, an OPCUA device block 82, an Other Protocol device block 84, a 4-20 mA Input block 86, a Digital Output block 88 and a Digital Output block 90. The BACnet device block 76, the BACnet-enabled sensor block 78 and the Modbus block 80 are each operably coupled with a BSparkplugEdgeGateway block 92. The CPCUA device block 82 is operably coupled with a BSparkplugEdgeGateway block 94. The Other Protocol device block 84 is operably coupled with a BSparkplugEdgeGateway block 96. The 4-20 mA Input block 86, the Digital Output block 88 and the Digital Output block 90 are each coupled with an MQTT EON Node block 98. In the example shown, the BSparkplugEdgeGateway blocks 92, 94 and 96 are configured to convert messages received from the various end devices 76, 78, 80, 82 and 84 into messages that are compatible with the MQTT broker 32, and/or convert messages from MQTT broker 32 into messages that are compatible with the various end devices 76, 78, 80, 82 and 84.

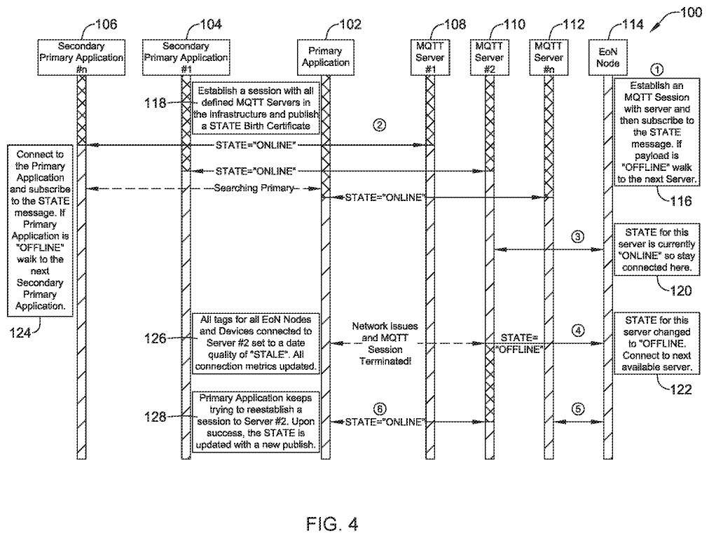

FIG. 4 is an illustrative primary host application high availability state flow diagram 100 that illustrates how state information flows between a Primary Host Application 102, a Secondary Primary Host Application (#1) 104 and a Secondary Primary Host Application (#n) 106. The state flow diagram 100 includes an MQTT Server (#1) 108, an MQTT Server (#2) 110, an MQTT Server (#n) 112 and in some cases an EoN Node 114. It will be appreciated that the state flow diagram 100 may include any number of MQTT servers.

At box 116, an MQTT session is established with an MQTT server and a State message is subscribed to. If the payload of the message is “OFFLINE”, communication with another MQTT server is attempted, such as the next MQTT server in line. At box 118, a session is established with a defined MQTT Server (such as one or more of the MQTT Server (#1) 108, the MQTT Server (#2) 110 or the MQTT Server (#n) 112. At box 120, the STATE for this MQTT server is currently “ONLINE” so a connection with this MQTT server is maintained. At box 122, the STATE for this MQTT server is currently “OFFLINE”, so a connection with the next MQTT server in line is established.

At box 124, a connection is made to the Primary Host Application 102 and the State message is subscribed to. If the Primary Host Application 102 is “OFFLINE”, a connection is established with the next Secondary Primary Host Application. At box 126, and in response to network issues and the MQTT session being terminated, all tags for EoN Nodes and Devices connected to MQTT server #2 are set to a data quality of “STALE” and all connection metrics are updated. At block 128, the Primary Host Application 102 keeps trying to reestablish a connection with MQTT Server (#2) 110. Upon success, the STATE is updated with a new publish.

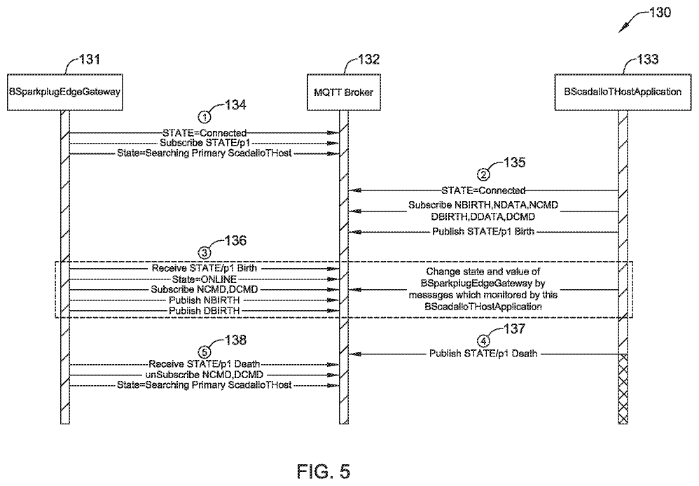

FIG. 5 is an illustrative state management process flow diagram 130 illustrating communication between a BSparkplugEdgeGateway 131 (Edge Gateway), an MQTT Broker 132 and a BScadalloTHostApplication 133 (Host Application). At a point 134, the BSparkplugEdgeGateway 131 is connected to the MQTT Broker 132 and has subscribed to the MQTT Broker 132. At a point 135, the BScadalloTHostApplication 133 is connected to the MQTT Broker 132. The BScadalloTHostApplication 133 has subscribed to particular information from the MQTT Broker 132 related to the Edge Gateway 131 and is publishing particular information to the MQTT Broker 132. At a point 136, the BSparkplugEdgeGateway 131 is subscribing to particular information from the MQTT Broker 132 and is publishing particular information to the MQTT Broker 132.

At a point 137, the BScadalloTHostApplication 133 has gone offline, and has published its State accordingly to the MQTT Broker 132. At a point 138, the BSparkplugEdgeGateway 131 has received the “offline” State information of the BScadalloTHostApplication 133 from the MQTT Broker 132. In response, the BSparkplugEdgeGateway 131 terminates its subscriptions and begins to search for a new primary BScadalloTHostApplication.

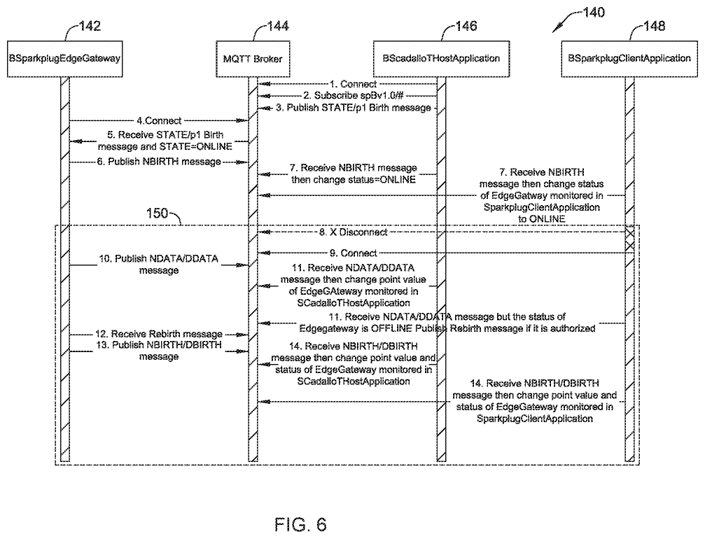

FIG. 6 is an illustrative initiative status update flow diagram 140 illustrating STATUS updates between a BSparkplugEdgeGateway 142, an MQTT Broker 144, a BScandalloTHostApplication 146 and a BSparkplugClientApplication 148. Individual steps are labeled 1, 2 . . . 14 within the flow diagram 140. A dotted line defines a box 150, which outlines what happens when the BSparkplugClientApplication 148 goes offline. At point 8, the BSparkplugClientApplication 148 disconnects from the MQTT Broker 144. At point 9, the BSparkplugClientApplication 148 connects to the MQTT Broker 144. At point 10, the BSparkplugEdgeGateway 142 publishes certain information to the MQTT Broker 144. At point 11, the BScandalloTHostApplication 146 receives the information from the MQTT Broker 144 (originally published by the BSparkplugEdgeGateway 142). At point 12, the BSparkplugClientApplication 148, which by now is back online, receives the information originally published by the BSparkplugEdgeGateway 142.

At point 13, the MQTT Broker 144 provides a rebirth message to the BSparkplugEdgeGateway 142, and the BSparkplugEdgeGateway 142 publishes new messages to the MQTT Broker 144. At point 14, the MQTT Broker 144 receives new NBIRTH/DBIRTH messages from the BScandalloTHostApplication 146 and from the BSparkplugClientApplication 148.

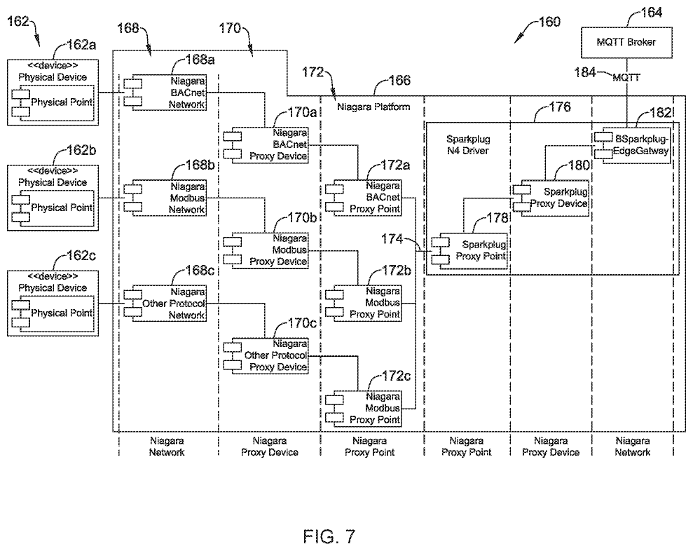

FIG. 7 is an illustrative flow diagram showing how messages from a number of physical end devices 162 are converted into sparkplug messages and ultimately provided to an MQTT Broker 164. The physical end devices 162 are divided into physical devices 162a that communicate via a BACnet protocol, physical devices 162b that communicate via a Modbus protocol and physical devices 162c that communicate via other protocols. A Niagara™ platform 166 sits between the physical end devices 162 and the MQTT Broker 164. The Niagara™ platform 166 includes Niagara™ network blocks 168, Niagara™ proxy device blocks 170 and Niagara™ Proxy Point blocks 172. The Niagara™ network blocks 168 include a Niagara™ BACnet network block 168a, a Niagara™ Modbus network block 168b and a Niagara™ Other Protocol network block 168c. The Niagara™ Proxy Device blocks 170 include a Niagara™ BACnet Proxy Device block 170a, a Niagara™ Modbus Proxy Device block 170b, and a Niagara™ Other Protocol Proxy Device block 170c. The Niagara™ Proxy Point blocks 172 include a Niagara™ BACnet Other proxy point 172a, a Niagara™ Modbus proxy point 172b and a Niagara™ Protocol proxy point 172c.

Each of the Niagara™ BACnet proxy point 172a, the Niagara™ Modbus proxy point 172b and the Niagara™ Other Protocol proxy point 172c communicate via a Niagara™ Link 174 with a Sparkplug N4 Driver 176. The Sparkplug N4 Driver 176 includes a Sparkplug Proxy Point block 178, a Sparkplug Proxy Device block 180 and a BSparkplugEdgeGateway block 182. The Sparkplug N4 driver 176 communicates with the MQTT Broker 164 via an MQTT link 184.

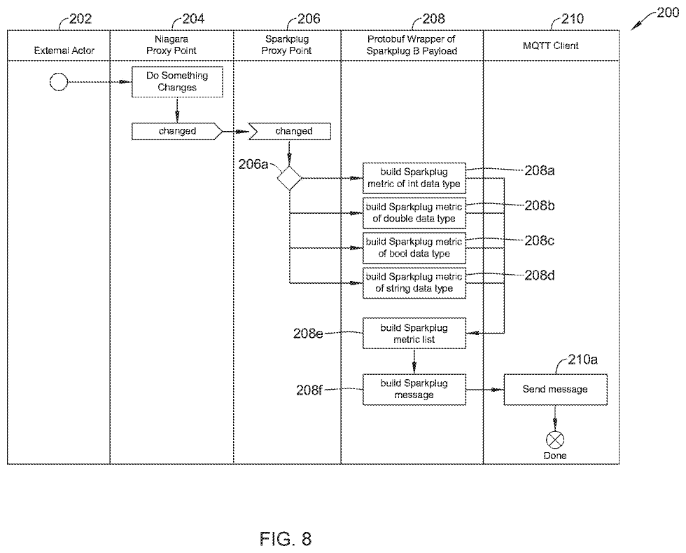

FIG. 8 is an illustrative flow diagram 200 showing how device or sensors data is converted into sparkplug messages using the system shown in FIG. 7. The flow diagram 200 is divided into an External Actor column 202, a Niagara™ Proxy Point column 204, a Sparkplug Proxy Point column 206, a Protobuf Wrapper of Sparkplug B Payload column 208 and an MQTT client column 210. As referenced at column 204, the Niagara™ Proxy Point (see FIG. 7) recognizes that a change has occurred. As referenced at column 206, the Sparkplug Proxy Point is informed of the change. At a decision block 206a, a determination is made as to the specific data type. In this example, options include integer, double, Boolean or string.

Depending on the data type, control flows to a particular block within the Protobuf Wrapper of Sparkplug B Payload column 208. If the data type is integer, a Sparkplug metric of integer data type is built, as indicated at block 208a. If the data type is double, a Sparkplug metric of double data type is built, as indicated at block 208b. If the data type is Boolean, a Sparkplug metric of Boolean data type is built, as indicated at block 208c. If the data type is string, a Sparkplug metric of string data type is built, as indicated at block 208d. The outputs of each of these blocks 208a, 208b, 208c and 208d flows to a block 208e, where a Sparkplug metric list is built. At a block 208f, a Sparkplug message is built from the Sparkplug metric list. As seen in column 210, the Sparkplug message is sent at block 210a.

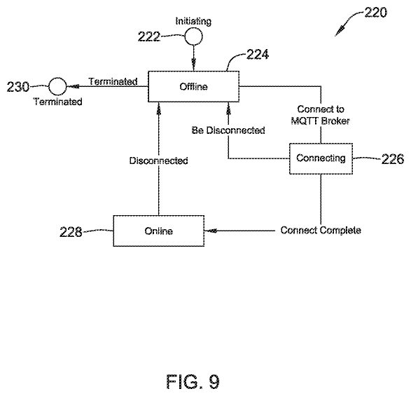

FIG. 9 is a flow diagram 220 showing an illustrative state machine of the BScadalloTHostApplication (Host Application). Control begins at an initiation point 222, and flows to a block 224, where the state is OFFLINE. From there, an MQTT broker is contacted and communication is established, as indicated at block 226. Once the connection has been completed, and as indicated at block 228, the state is now ONLINE. In some cases, from block 226, the connection is disconnected, and control reverts to block 224. In some cases, from block 228, the connection is disconnected, and control reverts to block 224. Control passes to a termination block 230.

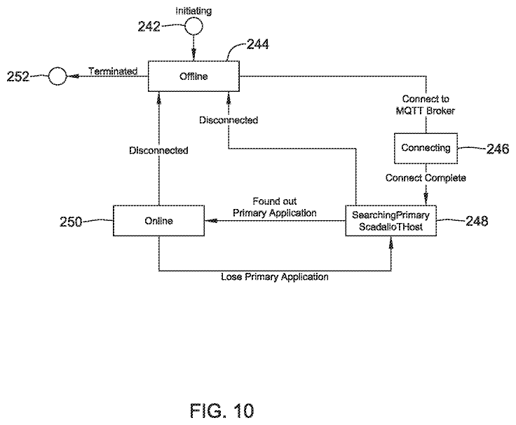

FIG. 10 is a flow diagram 240 showing an illustrative state machine of the BSparkplugEdgeGateway. Control begins at an initiation point 242, and flows to a block 244, where the state is OFFLINE. From there, an MQTT broker is contacted and communication is established, as indicated at block 246. Once the connection has been completed, control passes to block 248 where a search is performed looking for a PrimaryScadalloTHost. If disconnected, control reverts to block 244. If a Primary Application is found, control passes to block 250, where the status is ONLINE. If the Primary Application is subsequently lost, control reverts to block 248. Once online, a disconnection causes control to revert to block 244. Control passes to a terminal block 252.

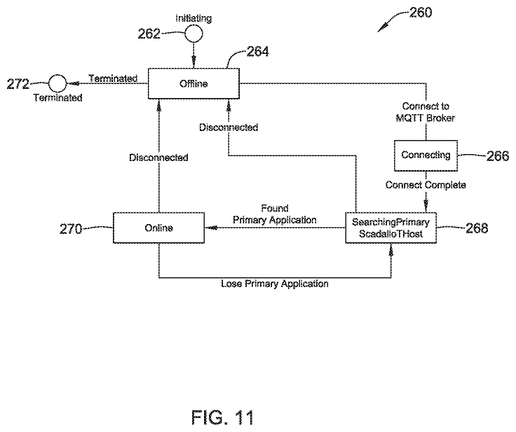

FIG. 11 is a flow diagram 260 showing an illustrative state machine of the BSparkplugClientApplication (Client Application). Control begins at an initiation point 262, and flows to a block 264, where the state is OFFLINE. From there, an MQTT broker is contacted and communication is established, as indicated at block 266. Once the connection has been completed, control passes to block 268 where a search is performed looking for a PrimaryScadalloTHost (Primary Host Application). If disconnected, control reverts to block 264. If a Primary Host Application is found, control passes to block 270, where the status is ONLINE. If the Primary Host Application is subsequently lost, control reverts to block 268. Once online, a disconnection causes control to revert to block 264. Control passes to a terminal block 272.

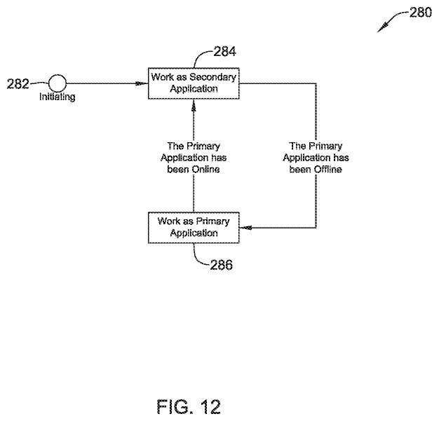

FIG. 12 is a flow diagram 280 showing an illustrative workflow of a Secondary Application becoming the Primary Application. Control begins at an initiation point 282 and flows to a block 284, indicating that a particular Host Application is functioning as a Secondary Application. If the Primary Host Application has been offline, control passes to a block 286, indicating that the Secondary Host Application is now functioning as the Primary Host Application. If the previous Primary Host Application regains its ONLINE state, control reverts to block 284 and the temporary Primary Host Application reverts to a Secondary Host Application status.

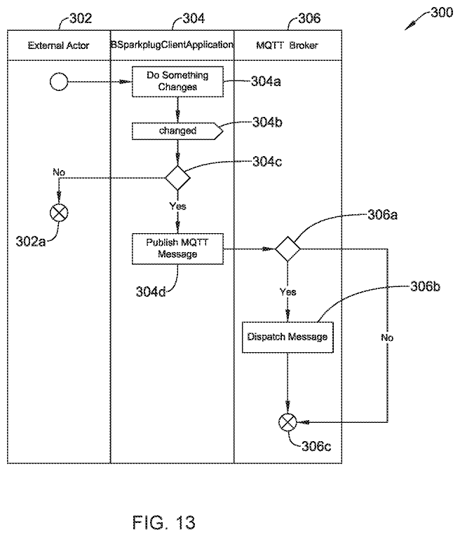

FIG. 13 is a flow diagram 300 showing an illustrative method of publish message permission control. The flow diagram 300 is divided into an External Actor column 302, a BSparkplugClientApplication column 304 and an MQTT Broker column 306. A recognition occurs that a change has occurred, as indicated at blocks 304a and 304b. A decision block 304c indicates that the BSparkplugClientApplication (Client Application) determines whether a message of this topic can be published by the Client Application. If so, control passes to block 304d, where the MQTT message is published. If not, control passes to termination point 302a.

Once the MQTT message has been published, control passes to block 306a, wherein the MQTT broker determines if it can publish the message of this topic. If so, control passes to block 306b and the message is dispatched, followed by control passing to a terminal point 306c. If not, control passes to the termination point 306c.

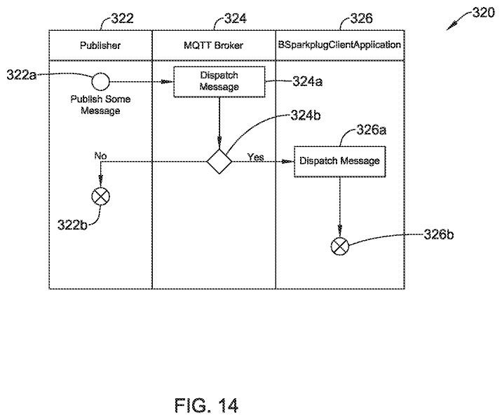

FIG. 14 is a flow diagram 320 showing an illustrative method of subscribe message permission control. The flow diagram 320 is divided into a Publisher column 322, an MQTT Broker column 324 and a BSparkplugClientApplication column 326. Control begins at point 322a, where the Publisher has published a message. Control flows to block 324a, where the MQTT Broker dispatches the message. At a decision block 324b, the MQTT Broker determines if the BSparkplugClientApplication (Client Application) has read permission for this particular topic. If yes, control passes to block 326a, where the BSparkplugClientApplication consumes the message. Control then passes to a termination point 326b. If not, control passes to a terminal point 322a.

In some instances, the BSparkplugClientApplication (Client Application) has a number of supervisory functions, as outlined in the table below:

| No. | Function | Description |
|---|---|---|
| 1 | mqttMsgArrived(String topic, | For processing MQTT messages. Display the real-time |
| | MqttMessage mqttMessage) | connection status of BScadaIIoTHostApplication and |
| | | BSparkplugClientApplication according to the |
| | | message content. The message type that can be |
| | | processed is: STATE |
| 2 | sparkplugMsgArrived | Used to handle sparkplug messages. Change the status |
| | (SparkplugMessage msg) | and point value of BSparkplugEdgeGateway |
| | | monitored by BSparkplugClientApplication according |
| | | to the message content. The message types that can be |
| | | processed are: NBIRTH, DBIRTH, NDATA, |
| | | DDATA, NDEATH, DDEATH. |
| 3 | connectionLost(Throwable | When BSparkplugClientApplication is disconnected |
| | cause) | from the MQTT broker, set its state to OFFLINE |
| 4 | connectComplete( ) | When the BSparkplugClient application is |
| | | successfully connected with the MQTT broker, |
| | | subscribe to different types of messages and change its |
| | | state to SearchingPrimaryScadaIIoTHost. The message |
| | | types will be subscribed are: NBIRTH, DBIRTH, |
| | | NDATA, DDATA, NDEATH, DDEATH. |
| 5 | doConnect( ) | Connect to the configured MQTT broker. |
| 6 | doDisconnect( ) | Disconnect the configured MQTT broker. |
| 7 | canPubTopic(String topic) | Is it possible for BSparkplugClientApplication to |
| | | publish this topic. It depends on authorization. |
| 8 | pubCmd(BSparkplugMetricExt | Publish a command message to MQTT broker to |
| | metricExt) | change the point value of BSparkplugEdgeGateway |
| | | monitored by BSparkplugClient. The types of |
| | | messages that can be published are: NCMD, DCMD |
| | | if the client is authorized. |
| 9 | subAll( ) | Subscribe messages. The message types will be |
| | | subscribed are: NBIRTH, DBIRTH, NDATA, |
| | | DDATA, NDEATH, DDEATH. |
| 10 | unsubAll( ) | UnSubscribe messages. The message types will be |
| | | subscribed are: NBIRTH, DBIRTH, NDATA, |
| | | DDATA, NDEATH, DDEATH. |

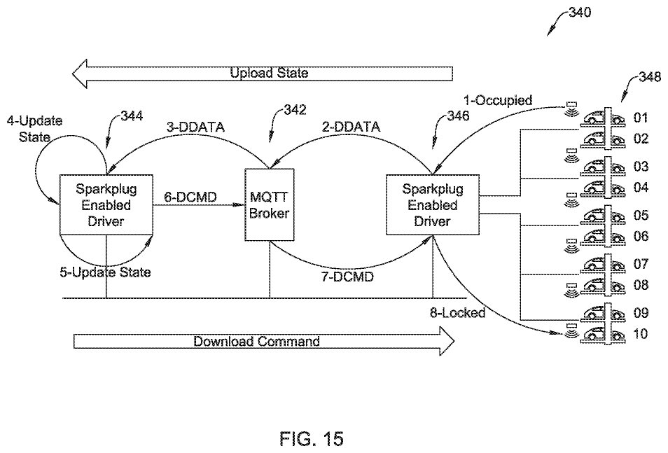

FIG. 15 is a schematic view of a system 340 that facilitates several illustrative use cases of the illustrative system of FIGS. 1-14. A first use case pertains to monitoring the occupancy status of parking spaces while a second use case pertains to reserving a parking space. The system 340 includes an MQTT broker 342 that may be on-site or remote, such as in the cloud. The illustrative system 340 includes a remote monitoring station 344 (Host and/or Client Application) and a JACE Edge Gateway 346. In this example, the system 340 monitors a number of parking spots 348.

In a first use case, a customer has driven to the supermarket for shopping and has parked their car in one of the parking spots 348. For this example, the customer has parked in parking space 1, area A, level 1. At this point, the JACE Edge Gateway 346 senses via one or more edge devices (sensors) that this parking space is now occupied, and sends a DDATA message to the MQTT broker 342. The message content being that the monitored space is now occupied. The remote monitoring station 344 has subscribed to this message and has changed the status of the particular parking space to occupied at the remote monitoring station 344 (Host and/or Client Application).

In a second use case, a customer desires to make a reservation for a particular parking spot 348. For this example, the customer wants to make a reservation for parking space 10, area A, level 1, so the customer clicks the reservation button on an application running on their mobile phone. The remote monitoring station 344 receives the request and sends a DCMD message to the MQTT broker 342. The content of the message is that the particular parking space is now locked. The JACE Edge Gateway 346 subscribes to the message and changes an indicator of an edge device that indicates that the parking space is now locked pursuant to the reservation, so that others cannot reserve or park in the reserved space.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A system comprising:
a message broker that uses a publish/subscribe messaging protocol;
an edge gateway operatively coupling one or more edge devices to the message broker, the edge gateway receiving information from one or more of the edge devices and publishing at least some of the received information to the message broker in a protocol that is compatible with the publish/subscribe messaging protocol of the message broker;
a host application operatively coupled to the message broker, the host application subscribing to at least some of the information published by the edge gateway to the message broker;
the edge gateway configured to determine an edge gateway connection state and publish the edge gateway connection state to the message broker, the edge gateway connection state including online and offline; and
the host application configured to determine a host application connection state of the host application and publish the host application connection state to the message broker, the host application connection state including online and offline.

2. The system of claim 1, wherein the host application connection state is set to online when the host application is connected to the message broker, and the host application connection state is set to offline when the host application is not connected to the message broker.

3. The system of claim 2, wherein the edge gateway connection state is set to online when the edge gateway is connected to the message broker and the host application connection state is set to online, and the edge gateway connection state is set to offline when the edge gateway is not connected to the message broker or when the edge gateway is connected to the message broker but the host application connection state is set to offline.

4. The system of claim 1, further comprising a plurality of host applications, wherein each of the plurality of host applications includes a host application identifier, with one of the plurality of host applications identified as a primary host application.

5. The system of claim 4, wherein when the host application connection state of the primary host application goes offline, another of the plurality of host applications is automatically identified as a new primary host application, and the edge gateway automatically switches to connect to the new primary host application via the message broker.

6. The system of claim 5, wherein the edge gateway connection state includes online, offline and searching for the primary host application.

7. The system of claim 6, wherein the edge gateway stores an ordered list of the plurality of host applications, wherein when the host application connection state of the primary host application goes offline, a next primary host application in the ordered list of the plurality of host applications is automatically identified as the new primary host application, and the edge gateway automatically switches to connect to the new primary host application via the message broker.

8. The system of claim 1, wherein the edge gateway is configured to convert at least some information received from one or more of the edge devices from a protocol that is incompatible with the publish/subscribe messaging protocol of the message broker to a protocol that is compatible with the publish/subscribe messaging protocol of the message broker before publishing the information to the message broker.

9. The system of claim 1, wherein the host application is configured to publish control information to the message broker to control one or more of the edge devices operatively coupled to the edge gateway, and the edge gateway is configured to subscribe to the control information published by the host application.

10. The system of claim 1, further comprising a client application operatively coupled to the message broker, the client application subscribing to at least some of the information published by the edge gateway to the message broker.

11. The system of claim 10, wherein the client application is configured to publish control information to the message broker to control one or more of the edge devices operatively coupled to the edge gateway, wherein the message broker is configured to verify that the client application is authorized to publish control information for the one or more edge devices, and if the client application is not authorized, the message broker is configured to not deliver the published control information.

12. The system of claim 1, wherein the message broker is an MQTT message broker, and the publish/subscribe messaging protocol comprises a sparkplug publish/subscribe messaging protocol.

13. The system of claim 1, wherein the one or more edge devices comprise one or more building control devices and/or building control sensors.

14. The system of claim 1, wherein the protocol that is incompatible with the publish/subscribe messaging protocol of the message broker includes one or more of OPC, Modbus and BACnet.

15. A system comprising:
a message broker that uses a publish/subscribe messaging protocol;
an edge gateway operatively coupling one or more edge devices to the message broker, the edge gateway receiving information from one or more of the edge devices and publishing at least some of the received information to the message broker in a protocol that is compatible with the publish/subscribe messaging protocol of the message broker;
a host application operatively coupled to the message broker, the host application subscribing to at least some of the information published by the edge gateway to the message broker; and
wherein the edge gateway is configured to convert at least some information received from one or more of the edge devices from a protocol that is incompatible with the publish/subscribe messaging protocol of the message broker to a protocol that is compatible with the publish/subscribe messaging protocol of the message broker before publishing the information to the message broker.

16. The system of claim 15, further comprising:
the edge gateway configured to determine an edge gateway connection state and publish the edge gateway connection state to the message broker.

17. The system of claim 15, further comprising:
the host application configured to determine a host application connection state of the host application and publish the host application connection state to the message broker.

18. The system of claim 17, further comprising a plurality of host applications, wherein each of the plurality of host applications includes a host application identifier, with one of the plurality of host applications identified as a primary host application, and wherein when the host application connection state of the primary host application goes offline, another of the plurality of host applications is automatically identified as a new primary host application, and the edge gateway automatically switches to connect to the new primary host application via the message broker.

19. A system comprising:
a message broker that uses a publish/subscribe messaging protocol;
an edge gateway operatively coupling one or more edge devices to the message broker, the edge gateway receiving information from one or more of the edge devices and publishing at least some of the received information to the message broker in a protocol that is compatible with the publish/subscribe messaging protocol of the message broker;
a plurality of host applications operatively coupled to the message broker, the plurality of host applications including a primary host application that subscribes to at least some of the information published by the edge gateway to the message broker; and
wherein when the primary host application connection goes offline, another of the plurality of host applications is automatically identified as a new primary host application, and the edge gateway and the new primary host application automatically connect via the message broker.

20. The system of claim 19, wherein when the edge gateway and the new primary host application automatically connect, the new primary host application subscribes to the at least some of the information published by the edge gateway and the edge gateway automatically republish at least some of the information previously published to the message broker by the edge gateway.
